(19) United States
(12) Patent Application Publication
(10) Pub. No.: US 2016/0108823 A1
(43) Pub. Date: Apr. 21, 2016

(54) APPARATUS FOR CONTROLLING THROTTLE VALVE AND LIMITING SPEED OF VEHICLE

(71) Applicant: Jung Suk CHUN, Daejeon (KR)

(72) Inventor: Jung Suk CHUN, Daejeon (KR)

(21) Appl. No.: 14/728,476

(22) Filed: Jun. 2, 2015

(30) Foreign Application Priority Data
Oct. 17, 2014 (KR) 10-2014-0140611

(51) Int. Cl. F02D 9/10; F16K 31/62; F16K 31/60

(52) U.S. Cl. CPC F02D 9/1065; F16K 31/60; F16K 31/62

(57) ABSTRACT

Provided is an apparatus for controlling a throttle valve and limiting a speed of a vehicle, in which an upper limit of an opening of a throttle valve is set by a mechanical lever at an indoor driver's seat to limit a maximum value of an amount of mixture supplied to an engine of a vehicle so that a driver may drive the vehicle, thus a sudden unintended acceleration accident of the vehicle occurring due to an electronic control device can be prevented and a speed limit can be freely controlled so that the vehicle can be driven while maintaining a predetermined speed. The apparatus includes: a hollow housing (20); a shaft (30); an actuator (40) operated by a pedal and a handle (50) operated by hand; and a speed control device (60).

### BACKGROUND OF THE INVENTION

1. Field of the Invention

The present invention relates to an apparatus for controlling a throttle valve and limiting a speed of a vehicle, and more particularly, to an apparatus for controlling a throttle valve and limiting a speed of a vehicle, in which an upper limit of an opening of a throttle valve is set by a mechanical lever at an indoor driver's seat to limit a maximum value of an amount of mixture supplied to an engine of a vehicle so that a driver may drive the vehicle, thus a sudden unintended acceleration accident of the vehicle occurring due to an electronic control device can be prevented and a speed limit can be freely controlled so that the driver can drive the vehicle while maintaining a predetermined speed.

2. Description of the Related Art

In general, power generated by an engine is determined according to an amount of mixture supplied to the engine of a vehicle. Thus, the generated power may be controlled by controlling an opening of the throttle valve which controls the amount of mixture supplied to the engine.

Accordingly, with respect to the power generated in the engine, torque is increased by increasing a reduction gear ratio when starting the vehicle, and after the vehicle is started, the rotation speed is increased by gradually reducing the reduction gear ratio.

Meanwhile, when the reduction gear ratio of the vehicle is reduced, the gear is shifted to the highest transmission level. In this case, once the gear is shifted to the highest transmission level, the speed of the vehicle is determined according to the amount of the mixture supplied to the engine unless the gear is shifted to the lower transmission level.

This method of controlling the amount of the mixture interworks with an actuator pedal, which is a throttle valve located at a lower part of the driver's seat. Therefore, when the gear is not shifted, the speed may be maintained when the opening of the actuator pedal is constantly maintained.

Recently, needs for a cruise system, in which the vehicle is driven at a constant speed, are gradually increased as the length of highways are becoming longer, and the cruise system is disclosed in Korea Unexamined Patent Publication No. 10-2007-0031001 (hereinafter, called patent document 1).

As shown in FIG. 1, the vehicle cruise system disclosed in patent document 1 includes an engine ECU 7 including: an engine throttle body 3 having a throttle valve which controls an amount of a mixture supplied to an engine; an acceleration pedal 1 coupled to the engine throttle body 3 and an acceleration cable 9 to control an opening of the throttle valve; a cable actuator 2 to control the acceleration cable 9 connected to the throttle valve; a cruise switch 4 to set a cruise mode of the vehicle; a vehicle speed sensor 6 to detect a driving speed of the vehicle; and a cable actuator drive circuit 8 to control an overall operation of the engine and control the cable actuator 2 such that the vehicle is driven at a constant speed according to an instruction of the cruise switch 4. In this case, a brake sensor 5 is further installed to detect an operation of a brake pedal so that the cruise mode of the vehicle is released when the driver steps on the brake.

As disclosed in patent document 1, the sudden unintended acceleration accident occurs more frequently in the case of the vehicle having the automatic cruise system for controlling the acceleration and braking of the vehicle.

In addition, in the case of the vehicle having the automatic cruise system disclosed in patent document 1, since the automatic cruise system does not operate and the safety cannot be guaranteed when the electrical system malfunctions, it is dangerous to drive the vehicle.

In addition, “Apparatus for limiting speed of vehicle” of Korea Registered Utility Model No. 20-0462736 (hereinafter, called patent document 2) and Korea Registered Utility Model No. 20-0461802 (hereinafter, called patent document 3) does not require a separate electronic control device to drive the vehicle at a constant speed, thus the sudden unintended acceleration accident may be prevented, however, the driver needs to step on the vehicle pedal, thereby causing inconvenience.

As related arts, there are Korea Unexamined Patent Publication No. 10-2007-0031001(Patent document 0001), Korea Registered Utility Model No. 20-0462736 (Patent document 0002) and Korea Registered Utility Model No. 20-0461802(Patent document 0003).

### SUMMARY OF THE INVENTION

The present invention is provided to solve the problems described above, and an object of the present invention is to allow a driver to operate a sudden unintended acceleration control lever provided at a driver's seat inside a vehicle to limit an upper limit of an opening of a throttle valve so that a maximum value of an amount of a mixture supplied to an engine is limited, thus limiting the speed of the vehicle without a separate electronic control device.

In other words, an object of the present invention is to allow the driver to pull a restraining cable to an opposite direction of the throttle valve opening by using the sudden unintended acceleration control lever provided at the driver's seat so that the maximum value of the throttle valve is simply and easily limited thereby preventing the sudden intended acceleration accident.

In addition, an object of the present invention is to allow the vehicle to be driven at a predetermined speed while maintaining the opening of the throttle valve by fixing the speed control by a magnetic force through operating the speed control lever provided at the driver's seat.

The configuration of the present invention to achieve the object will be described below in detail with reference to the accompanying drawings.

According to the present invention, an apparatus for controlling a throttle valve and limiting a speed of a vehicle includes: a hollow housing 20 provided at an inner side of a cover 10 provided at an inner part of a driver's seat of a vehicle; a shaft 30 installed and driven at an inner side of the hollow housing 20; an actuator 40 operated by a pedal and a handle 50 operated by hand, which are installed at a side of the shaft 30, to drive the shaft 30; and a speed control device 60 installed at an opposite side of the shaft 30 to control a speed of the actuator 40.

In addition, in an embodiment of the present invention, the speed control device 60 includes a speed control lever 70 installed at the opposite side of the shaft 30 to control a rotation of the shaft 30; a magnetic member 71 installed on an end part of the speed control lever 70; and an iron piece 80 fixed to the magnetic member 71 through magnetic force to fix a predetermined speed of the actuator 40 coupled to the shaft 30 such that the vehicle is driven at the predetermined speed.

Further, in an embodiment of the present invention, a restraining cable 91 for restraining a throttle valve 90 coupled to the shaft 30 is pulled to an opposite direction by an operation of a sudden unintended acceleration control lever 100 such that an opening of the throttle valve 90 is controlled thereby preventing a sudden unintended acceleration.

The apparatus of the present invention limits the maximum value of the amount of the mixture supplied to the engine of all of the vehicles driving on a road by us a driving force so that equipment for preventing the sudden unintended acceleration from occurring may be installed inside the vehicle and the driver may easily and conveniently use the equipment.

In other words, when the mechanically installed sudden unintended acceleration control lever is used, the sudden unintended acceleration accident may be fundamentally prevented by the electronic device installed in the vehicle.

In addition, according to the present invention, the driver may easily operate the speed control device install inside the vehicle to freely control the speed limit of the vehicle so that the vehicle may be driven at a predetermined speed and the vehicle may be prevented from theft.

### BRIEF DESCRIPTION OF THE DRAWINGS

FIG. 1 is a view showing a configuration of an automatic cruise system according to patent document 1.

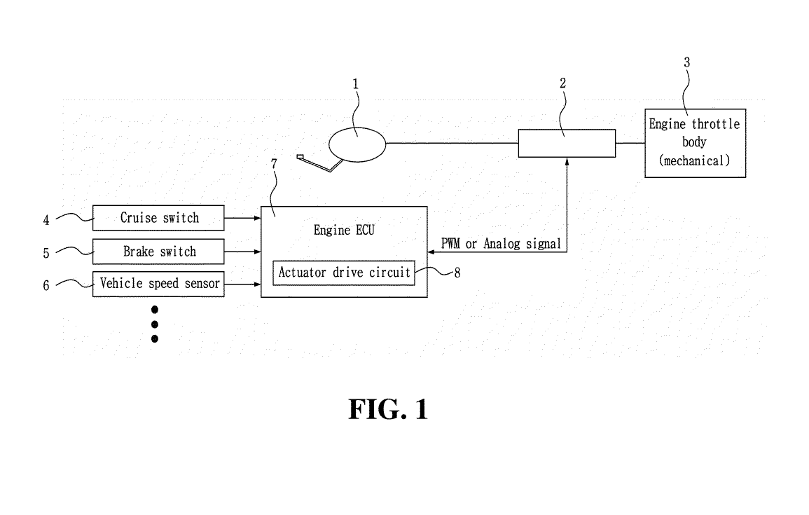

FIG. 2 is a schematic diagram showing an apparatus for controlling a throttle valve and limiting a speed of a vehicle according to an embodiment of the present invention.

FIG. 3 is a picture of the apparatus for controlling a throttle valve and limiting a speed of a vehicle according to an embodiment of the present invention installed in the vehicle.

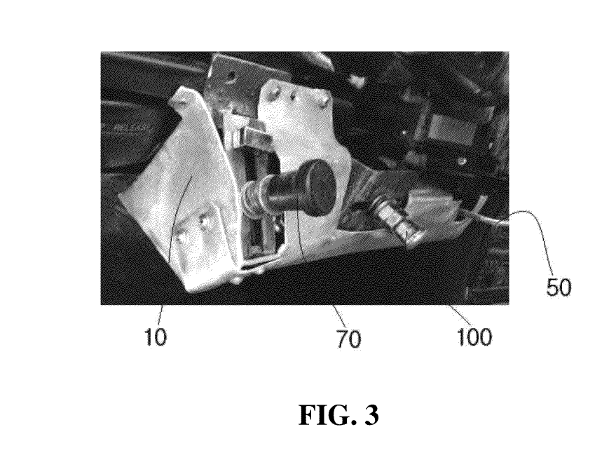

### DETAILED DESCRIPTION OF THE INVENTION

Hereinafter, an embodiment of the present invention is described in detail with reference to the accompanying drawings. While the present invention has been particularly shown and described by embodiments with reference to the accompanied drawings, it should not be interpreted in any way to limit the scope of the present invention. In addition, it will be understood by those of ordinary skill in the art that various substitutions, changes in form and alterations may be made therein without departing from the spirit and the scope of the present invention

As described above, the apparatus for controlling a throttle valve and limiting a speed of a vehicle according to an embodiment of the present invention includes: a sudden unintended acceleration control lever 100 to control a restraining cable 91, which controls an open/close state of the throttle valve 90, so that the restraining cable 91 is pulled to a direction opposite to when the throttle valve 90 is opened, and a speed control device 60 to control a shaft 30 which rotates when a vehicle is accelerated when an actuator 40 is operated.

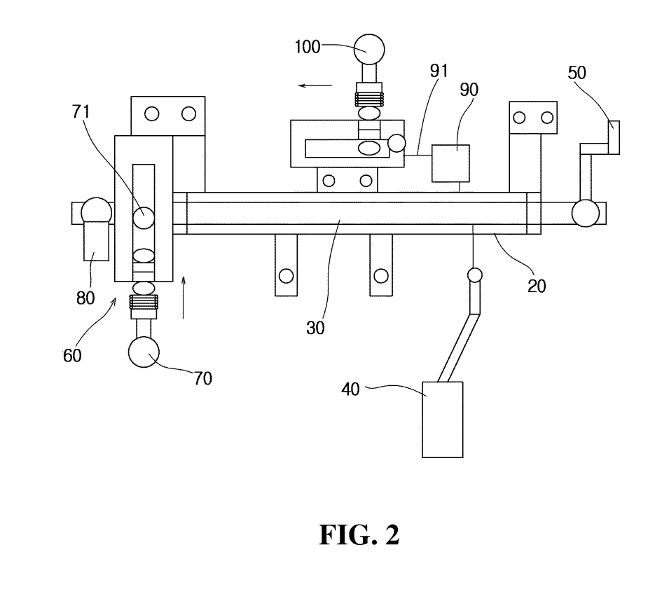

To describe the apparatus according to an embodiment of the present invention in detail with reference to FIG. 2, to prevent a sudden unintended acceleration and maintain a predetermined speed set by a user, a cover 10 is installed in the vehicle, and the shaft 30 rotates by an acceleration of the actuator 40 in a hollow housing 20 installed in the cover 10.

The shaft 30 is coupled to the actuator (acceleration pedal) and is rotated and accelerated when the actuator 40 is operated.

In this case, instead of being rotated and accelerated when the actuator 40 is operated, to manually accelerate the rotation of the shaft 30, a handle 50 is installed at an end part of a side of the shaft 30.

In addition, to prevent the sudden unintended acceleration when the vehicle is started, a throttle valve 90 is coupled to the shaft 30 by a restraining cable 91 and the restraining cable 91, which is coupled to the throttle valve 90, is coupled to the sudden unintended acceleration control lever 100.

In addition, when the sudden unintended acceleration control lever 100 is operated to a left direction in FIG. 2, because the restraining cable 91 coupled to the sudden unintended acceleration control lever 100 is configured to be pulled to a direction opposite to when the throttle valve 90 is open, even when the actuator 40 is operated, the throttle valve 90 is prevented from opening.

Therefore, even when the driver steps on the actuator 40, because the restraining cable is pulling from the opposite side, the throttle valve 90 is prevented from opening thereby preventing the sudden unintended acceleration.

In addition, the speed control device 60 is installed at the other side of the shaft 30 coupled to the handle 50. The speed control device 60 is coupled to the actuator 40 to prevent the shaft 30, which rotates to drive the acceleration, from rotating at a predetermined speed.

In other words, in the speed control device 60, a speed control lever 70 is installed at an end part of the shaft 30 and a magnetic member 71 is installed in an end part of the speed control lever 70.

In addition, when the speed control lever 70 is operated to an upper direction in FIG. 2, the shaft 30 is rotated and the magnetic member 71 installed at the end part of the speed control lever 70 is fixed to an iron piece 80 installed at a side of the shaft 30.

Therefore, because the magnetic member 71 installed on the speed control lever 70 is fixed to the iron piece 80, the rotation by the acceleration of the shaft 30 is stopped so the vehicle is driven only at the predetermined speed.

Therefore, even when the driver continuously operates the actuator 40 by stepping on the actuator 40, because the magnetic member 71 of the speed control lever 70 installed on the shaft 30 is fixed to the iron piece 80, the shaft 30 is prevented from rotating so the vehicle is driven by maintaining the speed preset by the driver.

In addition, for the driver to control the speed again, when the speed control lever 70 is pulled to a lower direction in FIG. 2, the shaft 30 rotates in a reverse direction to separate the magnetic member 71 fixed to the iron piece 80, and the separated magnetic member 71 moves to an original position by a spring 72. Therefore, the driver may operate the actuator 40 to drive at a desired speed.

What is claimed is:

1. An apparatus for controlling a throttle valve and limiting a speed of a vehicle, the apparatus comprising:
a hollow housing (20) provided at an inner side of a cover (10) provided at an inner part of a driver's seat of a vehicle;
a shaft (30) installed and driven at an inner side of the hollow housing (20);
an actuator (40) operated by a pedal and a handle (50) operated by hand, which are installed at a side of the shaft 30, to drive the shaft (30); and
a speed control device (60) installed at an opposite side of the shaft (30) to control a speed of the actuator (40).

2. The apparatus according to claim 1, wherein the speed control device (60) comprises:
a speed control lever (70) installed at the opposite side of the shaft (30) to control a rotation of the shaft (30);
a magnetic member (71) installed on an end part of the speed control lever (70); and
an iron piece (80) fixed to the magnetic member (71) through magnetic force to fix a predetermined speed of the actuator (40) coupled to the shaft (30) such that the vehicle is driven at the predetermined speed.

3. The apparatus according to claim 1, further comprising a restraining cable (91) for restraining a throttle valve (90) coupled to the shaft (30), wherein the restraining cable (91) is pulled to an opposite direction by an operation of a sudden unintended acceleration control lever (100) such that an opening of the throttle valve (90) is controlled thereby preventing a sudden unintended acceleration.

4. The apparatus according to claim 2, further comprising a restraining cable (91) for restraining a throttle valve (90) coupled to the shaft (30), wherein the restraining cable (91) is pulled to an opposite direction by an operation of a sudden unintended acceleration control lever (100) such that an opening of the throttle valve (90) is controlled thereby preventing a sudden unintended acceleration.
